(19) United States
(12) Patent Application Publication
(10) Pub. No.: US 2016/0105651 A1
(43) Pub. Date: Apr. 14, 2016

(54) PROJECTOR AND METHOD FOR MIXING LIGHT BY A PROJECTOR

(71) Applicants: QISDA OPTRONICS (SUZHOU) CO., LTD., Suzhou (CN); QISDA CORPORATION, Toyuan City (TW)

(72) Inventor: Kai-Jing Wang, Tainan City (TW)

(21) Appl. No.: 14/877,921

(22) Filed: Oct. 7, 2015

(30) Foreign Application Priority Data
Oct. 9, 2014 (TW) 103135287

(51) Int. Cl. H04N 9/31; G02B 26/00

(52) U.S. Cl. CPC H04N 9/3111; G02B 26/008; H04N 9/3161

(57) ABSTRACT

A method for mixing light in a projector includes mixing first light emitted by a solid state light emitter and second light into third light. The coordinates (x₃, y₃) of the third light in the Diagram of the CIE 1931 color space are within the range of 0.14≦x₃≦0.15 and 0.04≦y₃≦0.09.

### BACKGROUND OF THE INVENTION

1. Field of the Invention

This invention is related to a method for mixing light by a projector, and more particularly, a method for mixing light by a projector using a solid state light emitter.

2. Description of the Prior Art

Due to the concerns of pollutants caused by the mercury lamps, projectors using mercury lamps as light sources can be contradictory to the mainstream sense of environmental protection. Therefore a projector using a solid state light emitter, such as a light emitting diode or laser diode, to stimulate the phosphors as a light source has become a popular selection.

FIG. 1 shows a projector 100 according to prior art. The projector 100 includes a solid state light emitter 110, a phosphorous color wheel 120, a filter color wheel 130, and a light direction device 140. The solid state light emitter 10 is a light emitting diode for emitting a purplish-blue light P1. The light direction device 140 can direct the purplish-blue light P1 into the phosphorous color wheel 120. The phosphorous color wheel 120 includes a red light generation area 122, a green light generation area 124, and a blue light generation area 126. The filter color wheel 130 includes a red light filter area 132, a green light filter area 134, and a non-reflective transmissive area 136. The phosphorous color wheel 120 and the filter color wheel are rotating simultaneously, and the red light generation area 122 is corresponding to the red light filter area 132, the green light generation area 124 is corresponding to the green light filter area 134, and the blue light generation area 126 is corresponding to the non-reflective transmissive area 136.

The yellow phosphors are uniformly disposed on the red light generation area 122, and when the purplish-blue light P1 shines on the red light generation area 122, the yellow phosphors will be stimulated by the purplish-blue light P1 to emit a yellow light Y1. The yellow light Y1 can pass through the light direction device 140 and further to the red light filter area 132 of the filter color wheel 130. The red color filter area 132 can filter part of the yellow light Y1, so that the remaining part of the yellow light Y1 that are able to pass through the red light filter area 132 will be a red light R1 with purer red color.

The green phosphors are uniformly disposed on the green light generation area 124, and when the purplish-blue light P1 shines on the green light generation area 124, the green phosphors will be stimulated by the purplish-blue light P1 to emit a mixing green light G′1. The mixing green light G′1 can pass through the light direction device 140 and further to the green light filter area 134 of the filter color wheel 130. The green light filter area 134 can filter part of the mixing green light G′1, so that the remaining part of the mixing green light G′1 that are able to pass through the green color filter area 134 will be a green light G2 with purer green color.

When the purplish-blue light P1 shines on the blue light generation area 126, the purplish-blue light P1 will pass through the blue light generation area 126 and further to the light direction device 140. The light direction device 140 can direct the purplish blue light P1 to the non-reflective transmissive area 136 of the filter color wheel 130. Thus, the projector 100 can use the red light R1, the green light G2, and the purplish-blue light P1 as the color lights for displaying images.

The solid state light emitter 110 has some limitations on its physical characteristics, for example, according to the Diagram of the Commission Internationale de L'éclairage (CIE) 1931 color space, the coordinates (xₚ, yₚ) of the purplish-blue light P1 emitted by the laser diode is normally within the range of: 0.14≦xₚ≦0.15 and 0.01≦yₚ≦0.03. Since the CIE coordinates of the purplish-blue light P1 is obviously different from the coordinates of a standard blue light, (0.150, 0.060), defined by ITU-R Recommendation as BT.709, the laser diode cannot display blue light with pure blue color. Since the projector 100 uses the purplish-blue light as the required color light for displaying the image, the purplish image usually becomes an issues which causing the quality loss.

### SUMMARY OF THE INVENTION

One embodiment of the present invention discloses a method for mixing light by a projector. The projector comprises a solid state light emitter, a phosphorous color wheel, a filter color wheel, and a light direction device. The filter color wheel comprises a blue light filter layer. The method comprises disposing a plurality of phosphors on the phosphorous color wheel corresponding to the blue light filter layer of the filter color wheel, the solid state light emitter emitting a first light to the phosphorous color wheel to stimulate the plurality of phosphorous to induce a stimulated light, the light direction device directing part of the first light passing through the phosphorous color wheel to the blue light filter layer, the light direction device directing the stimulated light to the blue light filter layer, the blue light filter layer filtering the stimulated light to induce a second light, and mixing the first light and the second light passing through the blue light filter layer to make a third light.

Coordinates of the third light in the Diagram of the CIE 1931 color space are within a range of: 0.14≦x₃≦0.15 and 0.04≦y₃≦0.09, wherein x₃ and y₃ are X and Y coordinates of the third light in the Diagram of the CIE 1931 color space.

Another embodiment of the present invention discloses a method for mixing light by a projector. The projector comprises a light emitting diode, a shield, and a blue light filter layer. The method comprises disposing the shield to cover the light emitting diode, disposing a plurality of phosphors on the shield, the light emitting diode emitting a first light to the shield to stimulate the plurality of phosphorous to induce a stimulated light, disposing the blue light filter layer on or separated from the shield, directing the first light and the stimulated light passing through the shield to the blue light filter layer, the blue light filter layer filtering the stimulated light to induce a second light, and mixing the first light and the second light passing through the blue light filter layer to make a third light.

Another embodiment of the present invention discloses a projector. The projector comprises a solid state light emitter, a light induction unit, and a light direction device. The solid state light emitter is for emitting a first light, and the first light is a laser light. The light induction unit comprises a phosphorous color wheel, a plurality of phosphorous, and a filter color wheel. The phosphorous color wheel comprises a transmissive area configured to allow part of the first light to pass through. The plurality of phosphorous is disposed adjacent to the transmissive area, and the plurality of phosphorous are stimulated by part of the first light to induce a stimulated light. The filter color wheel comprises a blue light filter layer corresponding to the transmissive area and the plurality of phosphorous. The light direction device is for directing the first light to the phosphorous color wheel, directing part of first sequentially passing through the transmissive area and the blue light filter layer, and directing the stimulated light to the blue light filter layer. The blue light filter layer filters the stimulated light to induce a second light. Part of the first light and the second light passing through the blue light filter layer are mixed to make a third light.

Another embodiment of the present invention discloses a projector. The projector comprises a solid state light emitter, a plurality of phosphorous, a shield, and a blue light filter layer. The solid state light emitter is for emitting a first light, and the solid state light emitter is a light emitting diode. The plurality of phosphorous receives the first light to induce a stimulated light. The shield covers the solid state light emitter, and the plurality of phosphors are disposed on the shield. The blue light filter layer is disposed on or separated from the shield and for filtering the stimulated light to induce a second light. Part of the first light and the second light passing through the blue light filter layer are mixed to be a third light.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows a projector according to prior art.

FIG. 2 shows a projector according to one embodiment of the present invention.

FIG. 3 shows a projector according to another embodiment of the present invention.

FIG. 4 shows a projector according to another embodiment of the present invention.

FIG. 5 shows a projector according to another embodiment of the present invention.

FIG. 6 shows a flow chart of a method for mixing light by the projector in FIG. 2.

FIG. 7 shows a flow chart of a method for mixing light by the projector in FIG. 4.

FIG. 8 shows a flow chart of a method for mixing light by the projector in FIG. 5.

### DETAILED DESCRIPTION

FIG. 2 shows a projector 200 according to one embodiment of the present invention. The projector 200 includes a solid state light emitter 210 and a light induction unit 250. The solid state light emitter 210 can be configured to emit a first light L1. The light induction unit 250 can be configured to receive the first light L1 and to induce a second light L2. Part of the first light L1 can pass through the light induction unit 250 and can mix with the second light L2 to make a third light L3. The coordinates of each of the lights on the Diagram of the CIE 1931 color space according to the Commission Internationale de L'éclairage (CIE) can be called as the CIE coordinates of each of the lights for the purpose of convenient. The CIE coordinates of the third light L3 can be represented as (x₃, y₃) and can be within the range of:

0.14≦x_{3≦}0.15

0.04≦y_{3≦}0.09

That is, the third light L3 mixed by the first light L1 and the second light L2 can be a blue light. Due to the limitation of the physical characteristics of the solid state light emitter, the CIE coordinates of the first light L1 can be represented as (x₁, y₁) and are normally within the range of:

0.14≦x_{1≦}0.16

0.01≦y_{1≦}0.03

That is, the first light L1 is a purplish-blue light. To mix with the first light L1 and make a more accurate blue light, the CIE coordinates of the second light L2 can be represented as (x₂, y₂) and should be within the range of:

x₂<x₃

y₃<y₂<0.083

That is, the X coordinate x₂ of the second light L2 can be smaller than the X coordinate x₃ of the third light L3 so that when using the second light L2 to increase the Y coordinate y₃ of the third light, the X coordinate x₃ of the third light will not increase, otherwise, the increase of the X coordinate may cause the CIE coordinates of the third light to be out of the aforesaid range and make it more difficult to get the blue light with accurate blue color.

The light induction unit 250 can include a plurality of phosphors 252 and a filter unit 254. The plurality of phosphors 252 can be configured to receive the first light L1 to induce a stimulated light E1. The filter unit 245 can be configured to filter the stimulated light E1 to induce the second light L2. In some embodiments of the present invention, the phosphors 252 can be cyan phosphors or green phosphors, and thus the stimulated light E1 can be cyan stimulated light or green stimulated light.

In the embodiment in FIG. 2, the first light L1 can be laser light and the structure of the filter unit 254 can be a filter color wheel including a blue light filter layer 254B. The light induction unit 250 can further include a phosphorous color wheel 256. The filter unit 254 and the phosphorous color wheel 256 can be corresponding to each other and rotating simultaneously. Also, the phosphors 252 can be disposed on an area of the phosphorous color wheel 256 that is corresponding to the blue light filter layer 254B.

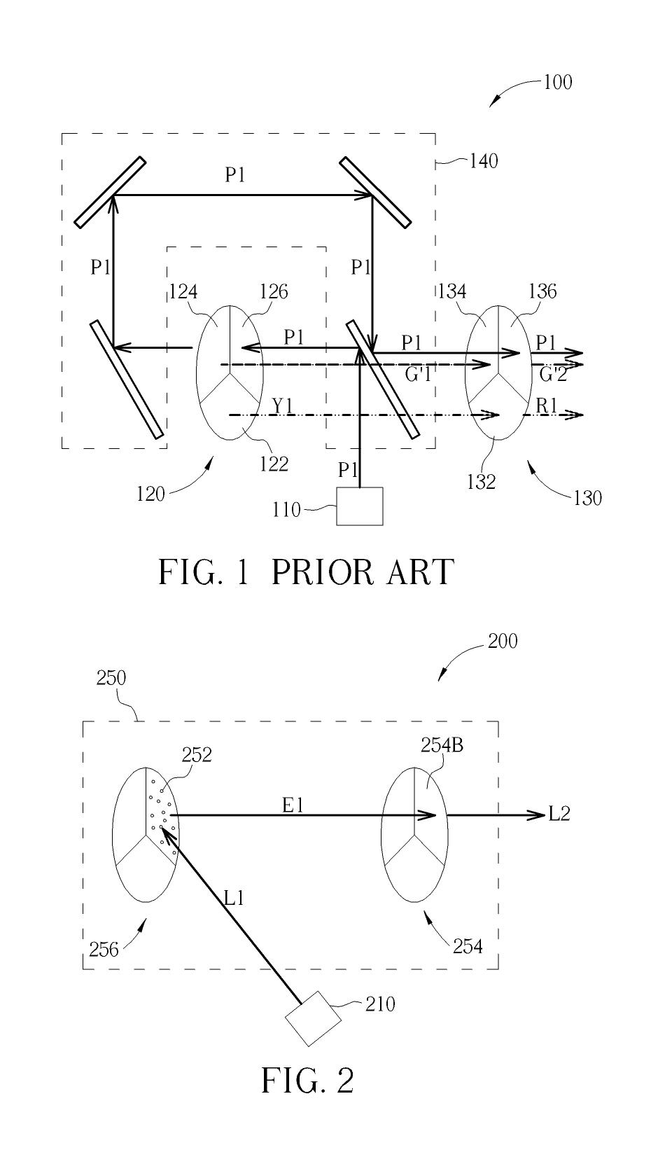

In some embodiments of the present invention, in addition to the aforesaid features, the filter unit 254 and the phosphorous color wheel 256 can also have the similar structure as the filter color wheel 130 and the phosphorous color wheel 120 in FIG. 1. However, this is not to limit the present invention. In other embodiments of the present invention, the filter unit 254 may only include the blue color filter layer 254B or the filter unit 254 may further include filter layers for other colors according to the system needs, and the phosphorous color wheel 256 may also include the corresponding color generation areas.

Furthermore, when the area of the phosphorous color wheel 256 in the light induction unit 250 that is corresponding to the blue light filter layer 254B receives the first light L1, part of the first light L1 can stimulate the phosphors 252 to emit the stimulated light E1. The stimulated light E1 can go into the blue light filter layer 254B, and the blue light filter layer 254B can filter the stimulated light E1 to induce the second light L2. In some embodiments of the present invention, the blue light filter layer 254B can be a filter glass that only allows lights with certain wavelengths to pass through, for example, but not limited to, a filter glass that only allows lights with wavelengths smaller than 500 nm to pass through, so that the CIE coordinates of the second light L2 can be within the aforesaid range.

Consequently, the projector 200 can mix the first light L1 emitted from the solid state light emitter 210 and the second light L2 induced by the light induction unit 250 according to the first light L1 to make the third light L3 of blue color and the issue of purplish image generated by the projector using the solid state light emitter can be solved, which can further improve the image quality.

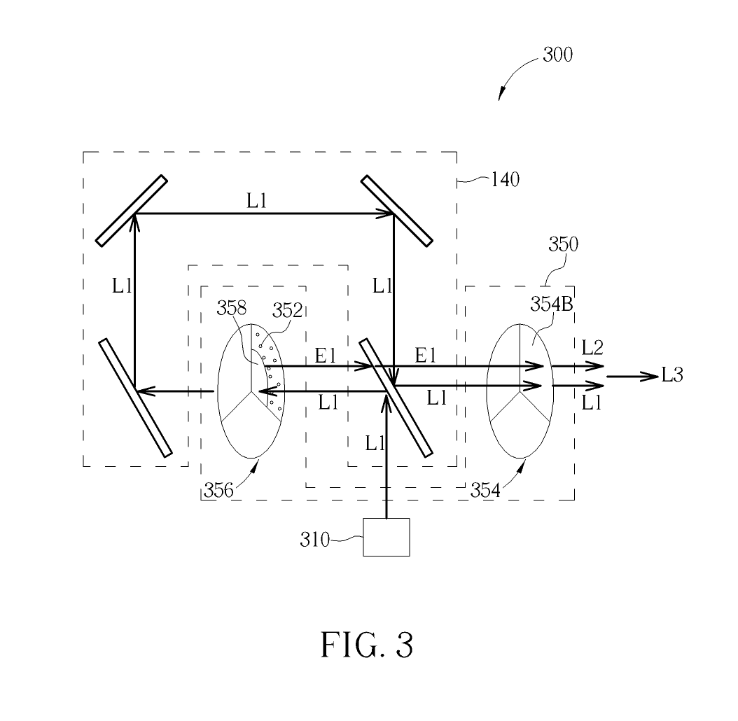

FIG. 3 shows a projector 300 according to another embodiment of the present invention. The projector 300 can include a solid state light emitter 310 and alight induction unit 350. The light induction unit 350 can include phosphors 352, a filter unit 354, and a phosphorous color wheel 356, and the filter unit 354 can include a blue light filter layer 354B. The operation principle of the projector 300 is similar to the operation principle of the projector 200, and the differences are in that the projector 300 can use the light direction device 140 to direct the first light L1 to the phosphorous color wheel 356 of the light induction unit 350. The area of the phosphorous color wheel 356 that is corresponding to the blue light filter layer 354B of the filter unit 354 can not only hold the phosphors 352 but can also include a non-reflective transmissive area 358 so that part of the first light L1 can pass through the area of the phosphorous color wheel 356 that is corresponding to the blue light filter layer 354B of the filter unit 354 and be directed by the light direction device 140 to blue light filter layer 354B of the filter unit 354. The stimulated light E1 emitted by phosphor 352 that is stimulated by the first light L1 can pass through the light direction device 140 and go to the blue light filter layer 354B of the filter unit 354. Since the wavelength of the first light L1 is shorter than the wavelength of the stimulated light E1, the first light L1 is able to pass through the blue light filter layer 354B and to mix with the second light L2 to make the third light L3.

Consequently, the projector 300 can mix the first light L1 emitted by the solid state light emitter 310 and the second light L2 induced by the light induction unit 350 according to the first light L1 to make the third light L3 of color blue, which can solve the issue of purplish image generated by the previous projector using solid state light emitter and further improve the image quality.

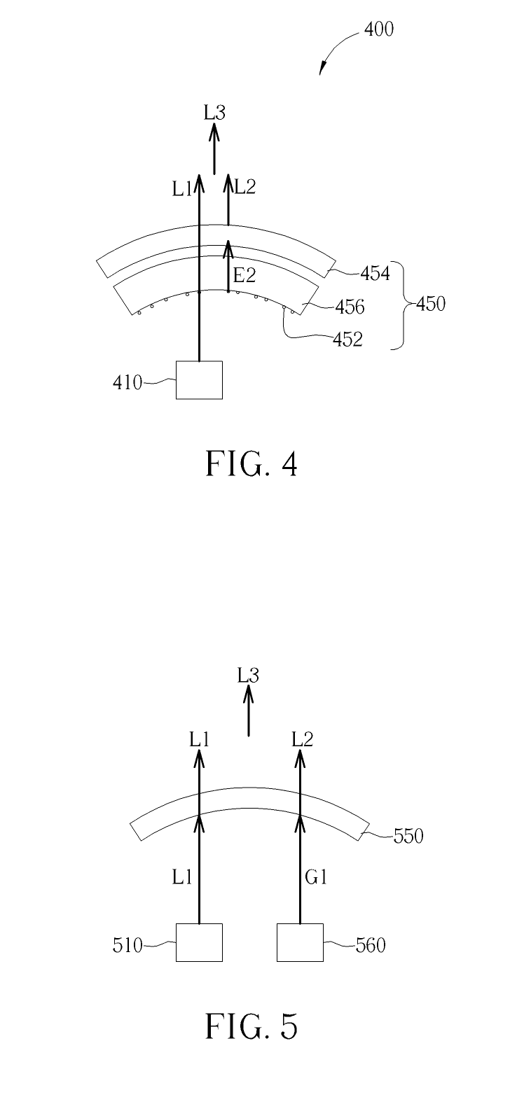

FIG. 4 shows a projector 400 according to another embodiment of the present invention. The projector 400 includes a solid state light emitter 410 and a light induction unit 450. The solid state light emitter 410 can be a light emitting diode configured to emit a first light L1. The CIE coordinates of the first light L1 can be represented as (x₁, y₁) and can be within the range of:

0.14≦x₁≦0.16

0.01≦y₁≦0.03

That is, the first light L1 is a purplish-blue light. The light induction unit 450 can receive the first light L1 and induce the second light L2. The light induction unit 450 can include a plurality of phosphors 452, a filter unit 454, and a shield 456. The shield 456 can cover the solid state light emitter 410. The phosphors 452 can be cyan phosphors or green phosphors configured to generate a cyan stimulated light or a green stimulated light. The phosphors 452 can be disposed on the shield 456.

In some embodiments of the present invention, the filter unit 454 can be a blue light filter layer that is independent of the shield 456. When the phosphors 452 on the shield 456 of the light induction unit 450 received the first light L1, the phosphors 452 can emit the cyan or green stimulated light E2. The stimulated light E2 will go to the filter unit 454, and the filter unit 454 can filter the stimulated light L2 to induce the second light L2. The filter unit 454 can be, for example but not limited to, a filter glass that allows lights with wavelengths smaller than 500 nm to pass through, so that the CIE coordinates of the second light L2 can be represented as (x₂, y₂) and can be within the range of:

x₂<x₃

y₃<y₂<0.083

Where, x₃ and y₃ represent for the coordinates of the third light L3 within the aforesaid range. In some embodiments of the present invention, the filter unit 454 can be disposed on the shield 456. For example, but not limited to, the filter unit 454 can be plated on the shield 456 and can filter the stimulated light E2 to induce the second light L2. Since the wavelength of the first light L1 can be shorter than the wavelength of the stimulated light E2, the first light L1 can pass through the filter unit 454 and mix with the second light L2 to make the third light L3.

Consequently, the projector 400 can mix the first light L1 emitted by the solid state light emitter 410 and the second light L2 induced by the light induction unit 450 according to the first light L1 to make the third light L3 of the color blue, which can solve the issue of purplish image generated by the projector using solid state light emitter and further improve the image quality.

FIG. 5 shows a projector 500 according to another embodiment of the present invention. The projector 500 includes a solid state light emitter 510, a light induction unit 550 and a green light emitting diode 560. The solid state light emitter 510 can be a light emitting diode configured to emit a first light L1. The CIE coordinates of the first light L1 can be represented as (x₁, y₁) and can be within the range of:

0.14≦x₁≦0.16

0.01≦y₁≦0.03

That is the first light is a purplish-blue light. The green light emitting diode 560 can be configured to emit a green light G1. The light induction unit 550 can be a blue light filter layer and can be configured to let the first light L1 to pass through and filter part of the green light G1 to induce the second light L2. The light induction unit 550 can be for example, but not limited to, a filter glass that allows lights with wavelengths smaller than 500 nm to pass through, so that the CIE coordinates of the second light L2 can be represented as (x₂, y₂) and can be within the range of:

x₂<x₃

y₃<y₂<0.083

Where (x₃, y₃) are the CIE coordinates of the third light L3 within the aforesaid range. In some embodiments of the present invention, the first light can also pass through the light induction unit 550 so the first light L1 and the second light L2 can be mixed to make the third light L3 of blue color.

Consequently, the projector 500 can mix the first light L1 emitted by the solid state light emitter 510 and the second light L2 induced by the light induction unit 550 to make the third light L3 of color blue, which can solve the issue of purplish image generated by the projector using solid state light emitter and further improve the image quality.

According to the aforesaid embodiments, the present invention can mix a first light and a second light to make a third light, while the CIE coordinates (x₃, y₃) of the third light can be within the range of 0.14≦x₃≦0.15 and 0.04≦y₃≦0.09 which can solve the issue of purplish image generated by the projector using solid state light emitter and further improve the image quality.

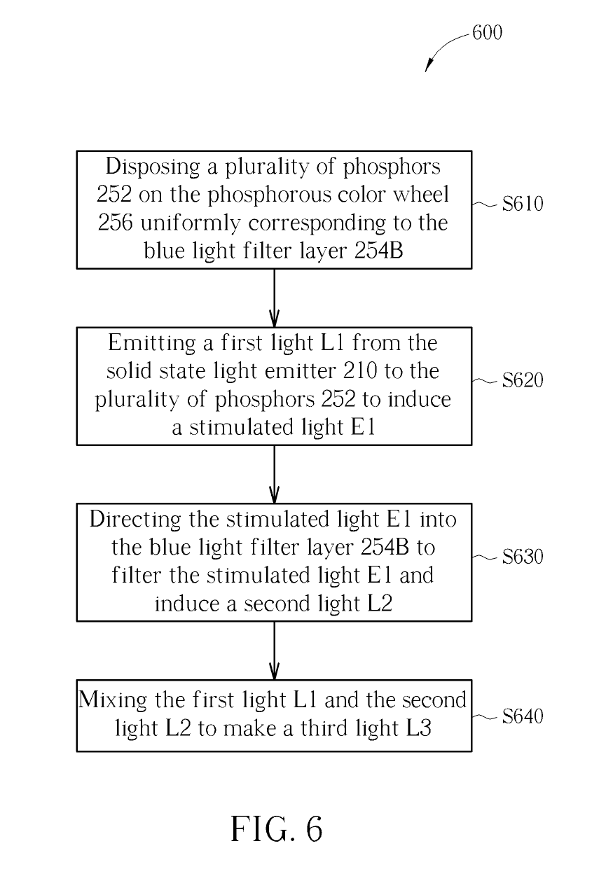

FIG. 6 shows a method 600 for mixing light by the projector 200. The method 600 includes steps S610 to S640.

S610: disposing a plurality of phosphors 252 on the phosphorous color wheel 256 uniformly corresponding to the blue light filter layer 254B;

S620: emitting a first light L1 from the solid state light emitter 210 to the plurality of phosphors 252 to induce a stimulated light E1;

S630: directing the stimulated light E1 into the blue light filter layer 254B to filter the stimulated light E1 and induce a second light L2;

S640: mixing the first light L1 and the second light L2 to make a third light L3.

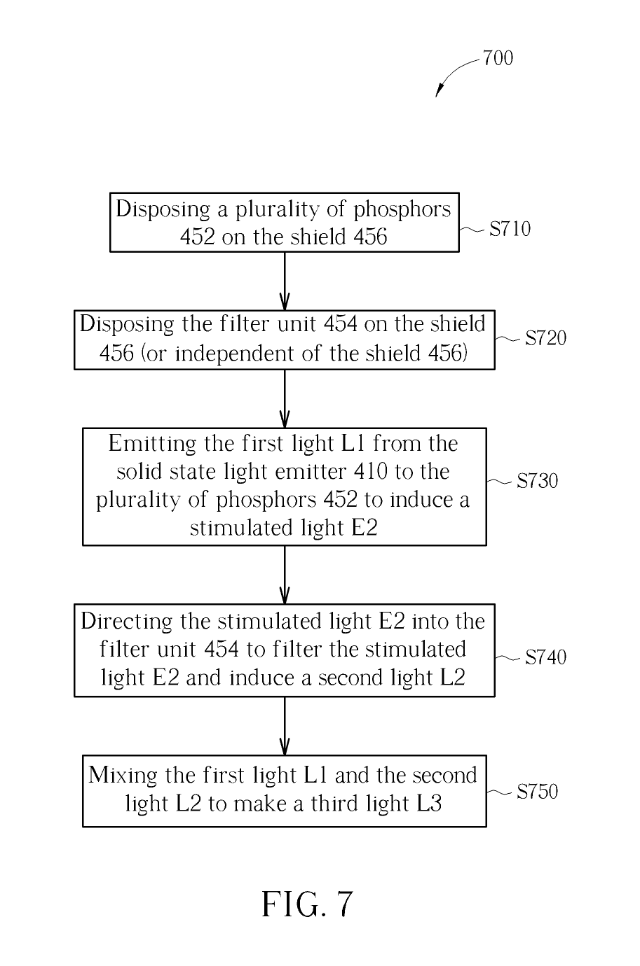

FIG. 7 shows a method 700 for mixing light by the projector 400. The method 700 includes steps S710 to S750.

S710: disposing a plurality of phosphors 452 on the shield 456;

S720: disposing the filter unit 454 on the shield 456 (or independent of the shield 456);

S730: emitting the first light L1 from the solid state light emitter 410 to the plurality of phosphors 452 to induce a stimulated light E2;

S740: directing the stimulated light E2 into the filter unit 454 to filter the stimulated light E2 and induce a second light L2;

S750: mixing the first light L1 and the second light L2 to make a third light L3.

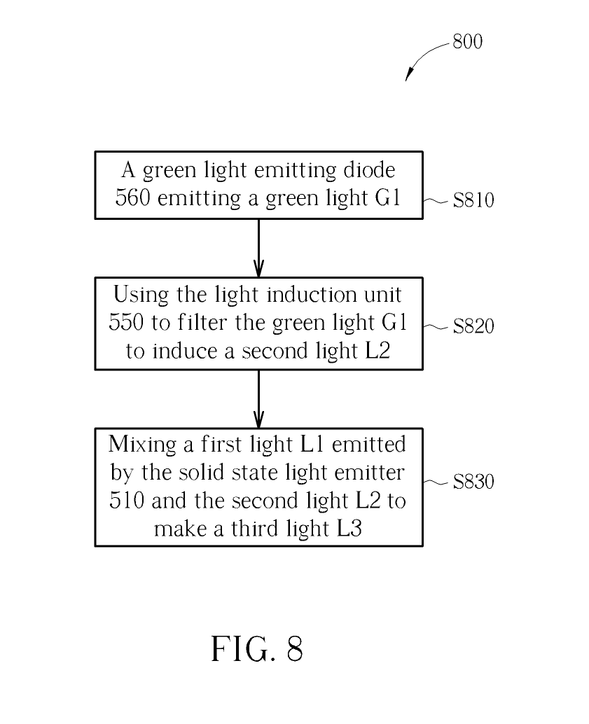

FIG. 8 shows a method 800 for mixing light by the projector 500. The method 800 includes steps S810 to S830.

S810: a green light emitting diode 560 emitting a green light G1;

S820: using the light induction unit 550 to filter the green light G1 to induce a second light L2;

S830: mixing a first light L1 emitted by the solid state light emitter 510 and the second light L2 to make a third light L3.

According to methods 600, 700 and 800, the first light L1 emitted by the solid state light emitter can be mixed with the second light L2 induced by the light induction unit to make the third light L3 of color blue, which can solve the issue of purplish image generated by the projector using solid state light emitter and further improve the image quality.

In summary, according to the projectors and the methods provided by the aforesaid embodiments of the present invention, the first light emitted by the solid state light emitter and a second light can be mixed to make a third light of blue color to solve the issue of purplish image generated by the previous projector using solid state light emitter and further improve the image quality.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for mixing light by a projector, the projector comprising a solid state light emitter, a phosphorous color wheel, a filter color wheel, and a light direction device, the filter color wheel comprising a blue light filter layer, and the method comprising:
disposing a plurality of phosphors on the phosphorous color wheel corresponding to the blue light filter layer of the filter color wheel;
emitting a first light from the solid state light emitter to the phosphorous color wheel to stimulate the plurality of phosphorous to induce a stimulated light;
directing part of the first light passing through the phosphorous color wheel to the blue light filter layer by the light direction device;
directing the stimulated light to the blue light filter layer by the light direction device;
filtering the stimulated light to induce a second light by the blue light filter layer; and
mixing the first light and the second light passing through the blue light filter layer to make a third light;
wherein, coordinates of the third light in the Diagram of the CIE 1931 color space are within a range of: 0.14≦x₃≦0.15 and 0.04≦y₃≦0.09, wherein x₃ and y₃ are X and Y coordinates of the third light in the Diagram of the CIE 1931 color space.

2. The method of claim 1, wherein coordinates of the first light in the Diagram of the CIE 1931 color space are within a range of: 0.14≦x₁≦0.16 and 0.01≦y₁≦0.03, wherein x₁ and y₁ are X and Y coordinates of the first light in the Diagram of the CIE 1931 color space.

3. The method of claim 2, wherein coordinates of the second light in the Diagram of the CIE 1931 color space are within a range of: x₂<x₃ and y₃<y₂<0.083; , wherein x₂ and y₂ are X and Y coordinates of the second light in the Diagram of the CIE 1931 color space.

4. The method of claim 1, wherein the plurality of phosphors are green phosphors and/or cyan phosphors.

5. A method for mixing light by a projector, the projector comprising a light emitting diode, a shield, and a blue light filter layer, and the method comprising:
covering the light emitting diode with the shield;
disposing a plurality of phosphors on the shield;
emitting a first light from the light emitting diode to the shield to stimulate the plurality of phosphorous to induce a stimulated light;
disposing the blue light filter layer on or separated from the shield;
directing the first light and the stimulated light passing through the shield to the blue light filter layer;
filtering the stimulated light to induce a second light by the blue light filter layer; and
mixing the first light and the second light passing through the blue light filter layer to make a third light.

6. A projector, comprising:
a solid state light emitter configured to emit a first light, the first light is a laser light;
a light induction unit comprising:
a phosphorous color wheel comprising a transmissive area configured to allow part of the first light to pass through;
a plurality of phosphorous disposed adjacent to the transmissive area, the plurality of phosphorous being stimulated by part of the first light to induce a stimulated light; and
a filter color wheel comprising a blue light filter layer corresponding to the transmissive area and the plurality of phosphorous; and
a light direction device configured to direct the first light to the phosphorous color wheel, direct part of first light sequentially passing through the transmissive area and the blue light filter layer, and direct the stimulated light to the blue light filter layer, the blue light filter layer filtering the stimulated light to induce a second light;
wherein part of the first light and the second light passing through the blue light filter layer are mixed to make a third light.

7. The projector of claim 6, wherein, coordinates of the third light in the Diagram of the CIE 1931 color space are within a range of: 0.14≦x₃0.15 and 0.04≦y₃≦0.09, wherein x₃ and y₃ are X and Y coordinates of the third light in the Diagram of the CIE 1931 color space.

8. The projector of claim 7, wherein coordinates of the first light in the Diagram of the CIE 1931 color space are within a range of: 0.14≦x₁≦0.16 and 0.01≦y₁≦0.03, wherein x₁ and y₁ are X and Y coordinates of the first light in the Diagram of the CIE 1931 color space.

9. The projector of claim 7, wherein coordinates of the second light in the Diagram of the CIE 1931 color space are within a range of: x₂<x₃ and y₃<0.083;, wherein x₂ and y₂ are X and Y coordinates of the second light in the Diagram of the CIE 1931 color space.

10. A projector, comprising:
a solid state light emitter configured to emit a first light, the solid state light emitter being a light emitting diode;
a plurality of phosphorous receiving the first light to induce a stimulated light;
a shield covering the solid state light emitter, wherein the plurality of phosphors are disposed on the shield; and
a blue light filter layer disposed on or separated from the shield and configured to filter the stimulated light to induce a second light;
wherein part of the first light and the second light passing through the blue light filter layer are mixed to be a third light.
